(19) United States
(12) Patent Application Publication
(10) Pub. No.: US 2020/0333980 A1
(43) Pub. Date: Oct. 22, 2020

(54) DATA PROCESSING SYSTEM AND OPERATING METHOD THEREOF

(71) Applicant: SK hynix Inc., Icheon (KR)

(72) Inventor: Min Soo LIM, Hwaseong (KR)

(21) Appl. No.: 16/693,076

(22) Filed: Nov. 22, 2019

(30) Foreign Application Priority Data
Apr. 17, 2019 (KR) 10-2019-0044981

(51) Int. Cl. G06F 3/06

(52) U.S. Cl. CPC G06F 3/0659; G06F 3/0673; G06F 3/061

(57) ABSTRACT

A data processing system may include a memory module composed of a plurality of memory banks including a plurality of pages; and a controller configured to control the memory module. The controller is configured to receive a type of an application of an operation to be offloaded and performed and a storage address of a program code of the application, to execute the program code, to store data generated as a result of the execution in the memory module, and to control, based on the type of the application, whether to refresh the memory module, a refresh cycle of the memory module, or both.

### CROSS-REFERENCES TO RELATED APPLICATION

The present application claims priority under 35 U.S.C. § 119(a) to Korean application number 10-2019-0044981, filed on Apr. 17, 2019, in the Korean Intellectual Property Office, which is incorporated herein by reference in its entirety.

### BACKGROUND

### 1. Technical Field

Various embodiments generally relate to a computing device, and more particularly, to a data processing system and an operating method thereof.

### 2. Related Art

With an increase in interest in and the importance of artificial intelligence applications and big data analysis, there is an increasing demand for a computing system capable of efficiently processing large capacity data.

While traditional computing systems have focused on processor-centric computing, recent computing systems have evolved into data-centric computing or memory-centric computing capable of processing an enormous amount of data in parallel at a high speed. This can reduce the effect of a data bottleneck that may arise between a processor and a memory, so that computational performance is maximized.

However, increasing the performance and speed of the computing device may cause an increase in energy consumption and heat generation.

### SUMMARY

In an embodiment, a data processing system may include a memory module including a plurality of memory banks, the memory banks including a plurality of pages; and a controller configured to control the memory module, wherein the controller is configured to: receive a type of an application and a storage address of a program code of the application, execute the program code, store data generated by the execution of the program code in the memory module, and control, based on the type of the application, whether to refresh the memory module or a refresh cycle of the memory module.

In an embodiment, an operating method of a data processing system, which includes a memory module composed of a plurality of memory banks including a plurality of pages and a controller configured to control the memory module, may include: when a host requests operation processing for an application, receiving, by the controller from the host, a type of the application and a storage address of a program code of the application; determining, by the controller, an address of the memory module into which the program code is loaded and an address of the memory module for storing data generated by the execution of the program code; and a refresh control step including controlling, by the controller based on the type of the application, whether to refresh the memory module, a refresh cycle of the memory module, or both.

### BRIEF DESCRIPTION OF THE DRAWINGS

FIG. 1 illustrates an electronic device including a data processing system in accordance with an embodiment.

FIG. 2 illustrates a memory module in accordance with an embodiment.

FIG. 3 illustrates a controller in accordance with an embodiment.

FIG. 4 illustrates a power management component in accordance with an embodiment.

FIGS. 5, 6, and 7 illustrate elements of a refresh cycle setting process in accordance with embodiments.

FIG. 8 is a flowchart illustrating an operating process of a data processing system in accordance with an embodiment.

FIGS. 9, 10, and 11 illustrate stacked semiconductor apparatus in accordance with embodiments.

FIG. 12 illustrates a network system including a data storage device in accordance with an embodiment.

### DETAILED DESCRIPTION

Hereinafter, a data processing system and an operating process thereof will be described in more detail with reference to the accompanying drawings.

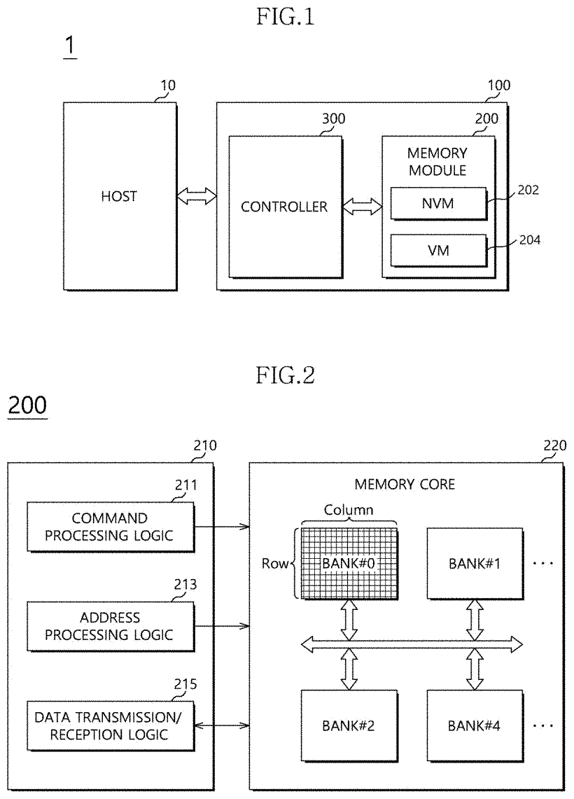

FIG. 1 illustrates an electronic device 1 including a data processing system in accordance with an embodiment.

The electronic device 1 may include a host 10 and a data processing system 100.

The electronic device 1 may include various electronic devices such as a personal computer, a server computer, a mobile computing device, and an electronic control device of a vehicle.

The electronic device 1 may include a high performance computing (HPC) device that performs advanced operations in a collaborative manner using a super computer or a computer cluster, or an array of networked information processing devices or servers that individually process data.

The host 10 may provide a user with various services through a user interface. To this end, the host 10 may transmit requests, addresses, and, if necessary, data related to data processing to the data processing system 100, and receive processing results thereof.

The data processing system 100 may perform corresponding operations in response to the requests and the addresses of the host 10, and transmit data to the host 10, if necessary.

The host 10 may transmit application-related information of an operation which is to be offloaded to and processed by the data processing system 100 to the data processing system 100. The application-related information may include an application type, a program code storage address of an application, and initial data. The data processing system 100 may perform the offloaded operation in accordance with the application-related information. Here “offloading” means entrusting an operation of the host 10 to another device, for example, the data processing system 100.

In an embodiment, the application type may be classified according to characteristics indicating whether data generated in a process may be lost without substantially affecting the correctness of the results produced by the process.

The data processing system 100 may include a memory module 200 and a controller 300.

The memory module 200 may store data or output the stored data under the control of the controller 300. The memory module 200 may include a volatile memory apparatus (VM) 204. Examples of the volatile memory apparatus 204 may include a dynamic random access memory (DRAM), a static random access memory (SRAM), and the like.

The memory module 200 may further include various nonvolatile memory apparatuses (NVM) 202 such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM), and the like, in addition to the volatile memory apparatus.

The controller 300 of the data processing system 100 may read a program code from a memory area corresponding to the application program code storage address provided from the host 10, load the program code into a first area of the memory module 200, and execute, that is, operate the program code. Data generated according to the execution may be stored in a second area of the memory module 200. In an embodiment, the program code may be stored in the nonvolatile memory apparatus 202. The controller 300 may load the program code of the nonvolatile memory apparatus 202 into a first area of the volatile memory apparatus 204 in response to an application processing request of the host 10. Data generated by executing the program code may be temporarily stored in a second area of the volatile memory apparatus 204 and then may be stored in the nonvolatile memory apparatus 202, if necessary.

In an embodiment, the program code stored in the first area is retained in the first area during the execution of an application. To this end, the controller 300 may refresh memory cells of the first area according to a preset refresh cycle.

In an embodiment, data stored in the second area by executing a machine learning or artificial intelligence application may be one-time, meaningless, or low importance data. Such data may not have an influence on application processing even though the data is not refreshed within a data retention time required in a standard applicable to the devices making up the volatile memory apparatus 204. In an embodiment, the controller 300 may not refresh memory cells included in the second area of the memory module 200, or may refresh the memory cells using a refresh cycle having a longer duration than the preset refresh cycle so that the memory cells included in the second area of the memory module 200 are refreshed less often than the memory cells in the first area.

The refresh is controlled to be performed less often or not to be performed for a memory area where data that may safely be lost (that is, may be lost without substantially affecting the correctness of a result) is stored, so that it is possible to reduce the amount of power consumed by the data processing system 100.

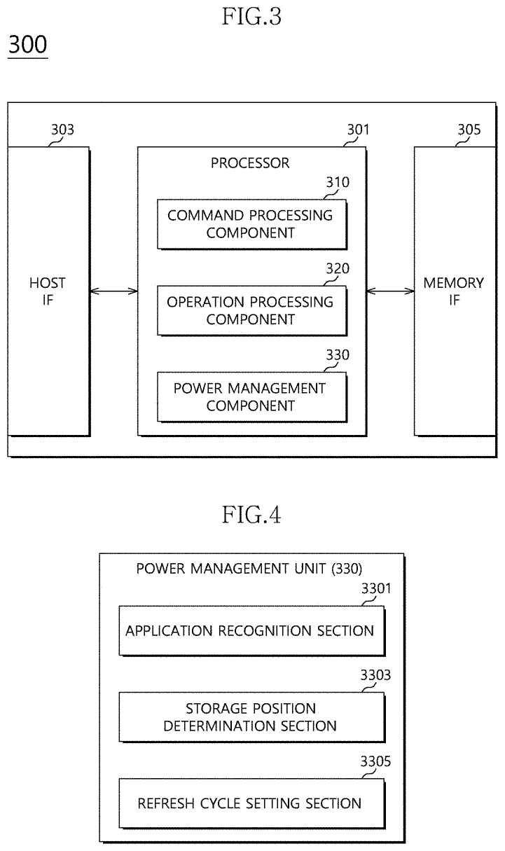

FIG. 2 is a configuration diagram of the memory module 200 in accordance with an embodiment.

The memory module 200 may include a logic circuit 210 and a memory core 220.

The logic circuit 210 may include a command processing logic 211, an address processing logic 213, and a data transmission/reception logic 215.

The command processing logic 211 may buffer and decode a command provided from the controller 300, and provide the decoded command to the memory core 220.

The address processing logic 213 may buffer and decode an address provided from the controller 300, and provide the decoded address to the memory core 220.

The data transmission/reception logic 215 may be configured to transfer data provided from the controller 300 to the memory core 220, and to transfer data provided from the memory core 220 to the controller 300.

The memory core 220 may include a plurality of banks. Each bank may include memory cells connected to a plurality of rows (which may be called pages) and columns. In an embodiment, the memory cell may be a DRAM cell.

The DRAM cell may be periodically refreshed in order to prevent the loss of data stored therein, and the refresh operation may be performed in a bank unit or a row (page) unit for each bank under the control of the controller 300 on the basis of an auto-refresh command generated in the command processing logic 211 or a self-refresh command generated in the logic circuit 210 itself.

The refresh cycle may be determined on the basis of the process, size, operation temperature and the like of the DRAM cell.

A refresh interval Tref for memory cells connected to a unit row may be set to be shorter than the data retention time of the memory cell. When respective rows are sequentially selected and refreshed according to a row address, a refresh cycle for completely refreshing memory cells connected to N rows constituting each bank of the memory module 200 may be set to Tref/N.

Accordingly, the refresh cycle may be set differently according to the characteristics of cells constituting the memory module 200 and the capacity of the memory module 200.

The periodic performance of the refresh operation increases the power consumption of the data processing system 100 and, by extension, the electronic apparatus 1. The power consumption incurred by refresh operations may increase in proportion to the amount of memory being refreshed. Because the data processing system 100 employed in artificial intelligence or machine learning typically employs a large capacity memory module 200 in order to process the enormous amount of data involved in such operations, there is a need for techniques that reduce the power consumption incurred by the periodic refresh operation.

According to an embodiment of the present disclosure, for a memory area storing data that may safely be lost, the refresh is controlled to be performed less often or not to be performed, thereby reducing the amount of power consumed by the data processing system 100.

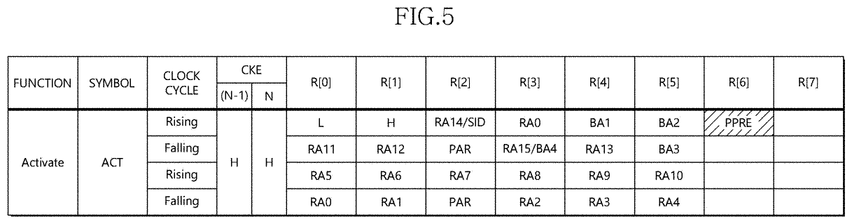

FIG. 3 illustrates a controller 300 in accordance with an embodiment.

The controller 300 may include a processor 301, a host interface (IF) 303, and a memory interface (IF) 305.

The processor 301 may be configured to transfer various types of control information required for a data read operation and a data write operation for the memory module 200 to the host IF 303 and the memory IF 305. In an embodiment, the processor 301 may process an operation requested by the host 10 in response to a command transmitted by the host 10. In order to process the operation requested by the host 10, the processor 301 may use data provided from the host 10 or the memory module 200.

In an embodiment, the processor 301 may perform a data processing function for a specialized application performed by the electronic apparatus 1. In an embodiment, the electronic apparatus 1 may perform a machine learning application requiring a high bandwidth or an artificial intelligence application involving machine learning processing, and the processor 301 may perform a data processing function specialized for such machine learning or artificial intelligence applications.

The host IF 303 may provide an interface between the host 10 and the data processing system 100. The host IF 303 may store and schedule a command provided from the host 10 and provide the scheduled command to the processor 301. The host IF 303 may provide the processor 301 or the memory IF 305 with data provided from the host 10 or provide the host 10 with data provided from the memory module 200 through the memory IF 305, under the control of the processor 301.

The memory IF 305 may transmit the data provided from the host IF 303 or the processor 301 to the memory module 200, or receive data read from the memory module 200 and provide the received data to the processor 301 or the host IF 303. To this end, the memory IF 305 may provide a communication channel for signal transmission/reception between the controller 300 and the memory module 200.

In an embodiment, the processor 301 may include a command processing component 310, an operation processing component 320, and a power management component 330.

The command processing component 310 may decode a command of the host 10 provided through the host IF 303 and produce signals according to the decoded command. The host 10 may instruct the data processing system 100 such that an operation for a specific application is offloaded to and processed by the operation processing component 320 of the controller 300, and the command processing component 310 may extract and decode the offload command and output corresponding control signals.

The operation processing component 320 may process the operation offloaded by the host 10 according to the program code loaded into the first area of the memory module 200 in response to the control signals outputted from the command processing component 310. Data generated as a result of the operation processing of the operation processing component 320 may be stored in a specific area of the memory module 200, for example, the second area, according to a register value set in advance.

In an embodiment, the operation processing component 320 may include an arithmetic logic unit (ALU) and a floating-point unit (FPU).

In an embodiment, in order to offload operation processing for a specific application to the data processing system 100, the host may transmit application-related information including an application type of the operation to be offloaded and performed, a program code storage address of the application, and initial data. The data processing system 100 may access the program code storage address, load the program code into the first area of the memory module 200, execute the program code stored in the first area to perform the operation, and store a result of performing the operation in the second area of the memory module 200.

The power management component 330 may be configured to manage an amount of power consumed by the memory module 200.

The application that the host 10 has offloaded to the data processing system 100 for performance by the data processing system 100 may be a machine learning application requiring a high bandwidth or a data processing function specialized for big data processing. In an illustrative example, the machine learning application may be an image processing application used in an autonomous vehicle. The autonomous vehicle may identify a surrounding situation using images of objects and/or animal around the vehicle as input data and then may not use input data any more. In another illustrative example, in processing big data, it may by that only a result value obtained by processing a large amount of inputted data is used and no input value is reused. In another illustrative example, in a convolutional neural network (CNN) application, a reduction in the resolution of an image used as input to the application may not influence the accuracy of the detection performed by the application.

As described above, for a data processing function for a specialized application, a large proportion of the data used by the data processing function may be one-time use data, meaningless data, low importance data, or combinations thereof.

Since such data does not need to be continuously maintained in the memory module 200, the power management u component 330 may eliminate unnecessary power consumption by controlling a refresh operation on a memory cell where such data is stored.

In an embodiment, the power management component 330 may control the refresh operation by using commands transmitted to a command interface of the memory module 200.

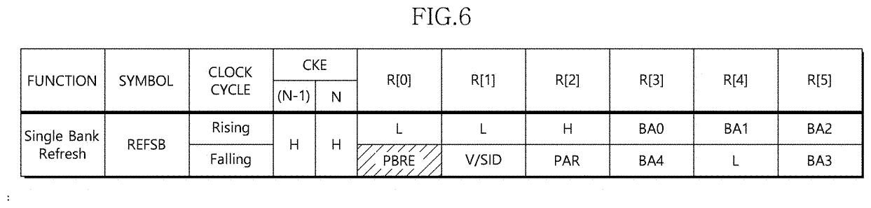

FIG. 4 illustrates the power management component 330 in accordance with an embodiment.

The power management component 330 may include an application recognition section 3301, a storage position determination section 3303, and a refresh cycle setting section 3305.

As the host 10 transmits application-related information of an operation to be offloaded to and processed by the data processing system 100, the application recognition section 3301 may recognize the application type of the operation. The application recognition section 3301 may determine, using the application type, whether data generated in processing the offloaded operation may safely be lost.

The storage position determination section 3303 may receive, from the operation processing component 320, the position of the first area where the program code is loaded and the position of the second area (which may be different than the first area) where data generated in processing the operation for the application is stored, wherein that data may safely be lost. In embodiments, data generated in processing the operation that may not be safely lost may be stored in the first area or in a third area different from the second area.

On the basis of the application type recognized by the application recognition section 3301 and the data storage position provided from the storage position determination section 3303, the refresh cycle setting section 3305 may set each of whether to refresh the first area (and if so, a refresh cycle of the first area) and whether to refresh the second area (and if so, a refresh cycle of the second is area).

In an embodiment, the refresh cycle setting section 3305 may control the memory cells included in the first area to be refreshed every preset cycle, e.g. once every X microseconds, where X is a predetermined positive number, and control the memory cells included in the second area to not to be refreshed or to be refreshed at a cycle longer than the preset cycle, e.g. once every Y microseconds, where Y is greater than X. In an embodiment, X microseconds may be less than an expected retention time of the memory cells in the first area, and Y microseconds may be greater than an expected retention time of the memory cells in the second area.

The refresh cycle setting section 3305 may provide refresh control information on the first area and the second area to the memory module 200 through the memory IF 305, thereby allowing the refresh cycles of the memory cells included in the first area and the second area to be controlled.

In an embodiment, the refresh cycle setting section 3305 may transmit the refresh control information by using a command transmitted through the command interface of the memory module 200. In an embodiment, the command for transmitting the refresh control information may be a command for controlling an operation in units of memory banks constituting the memory module 200 or a command for controlling an operation in units of rows for each memory bank. The command for controlling an operation in units of memory banks may be an active command; however, embodiments are not limited thereto. The command for controlling an operation in units of rows for each memory bank may be a refresh command for each bank; however, embodiments are not limited thereto.

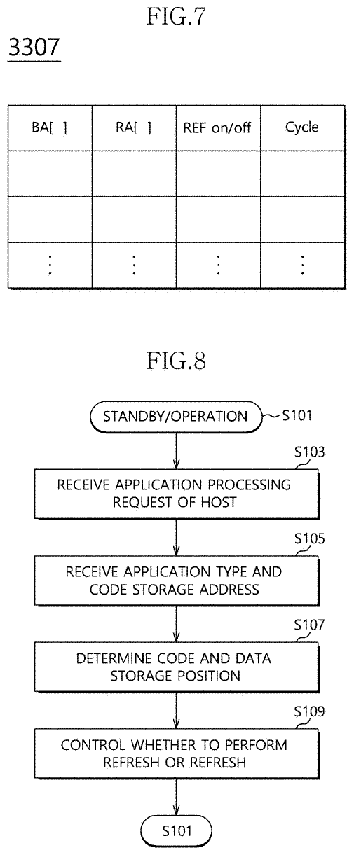

FIGS. 5, 6, and 7 illustrate features of a refresh cycle setting process in accordance with embodiments.

FIG. 5 and FIG. 6 illustrate the refresh cycle setting process using the command interface. FIG. 5 illustrates refresh control information transmission using the active command according to an embodiment.

The active command ACT is a command transmitted from the controller 300 to the memory module 200 in order to activate a specific memory bank among a plurality of memory banks included in the memory module 200 composed of the DRAM. The active command ACT may be transmitted over two clock cycles using both the rising and falling edges of the clock, and unused interface signals, for example, R[6] and R[7] may exist in an active command ACT according to the related arts. The refresh cycle setting section 3305 may transmit, on the rising edge of the first clock cycle used to transmit the refresh command REFSB to the memory module 200, a refresh control signal PPRE for each page through the otherwise-unused interface signals of the active command ACT.

Specifically, the storage position determination section 3303 may extract a bank address BA and a row address RA of the second area and transmit the refresh control signal PPRE for each page (i.e. each row) to control whether to perform a refresh or a refresh cycle for each row of the extracted bank.

The memory module 200 may extract the bank address BA, the row address RA, and the refresh control signal PPRE for each page included in the active command transmitted from the controller 300, and turn on or off a refresh operation on a corresponding row of a corresponding bank. For example, when a logic level of the refresh control signal PPRE for each page is a logic low level, no refresh may be performed on a corresponding row (indicated using the RAx bits of the active command ACT) of a corresponding bank (indicated using the BAx bits of the active command ACT).

FIG. 6 illustrates refresh control information transmission using the refresh command for each bank, according to an embodiment.

The refresh command REFSB for each bank is a command transmitted from the controller 300 to the memory module 200 in order to refresh a specific bank among the plurality of memory banks included in the memory module 200 composed of the DRAM, that is, to perform a refresh for each memory bank. The refresh command REFSB for each bank may be transmitted over 1-cycle using the rising and falling edges of a clock, and an unused interface signal, for example, R[0] on the falling edge of the clock cycle used to transmit the refresh command REFSB to the memory module 200, exists in a refresh command REFSB according to the related arts. The refresh cycle setting section 3305 may transmit, on the falling edge of the clock cycle, a refresh control signal PBRE for each bank through the otherwise-unused interface signal R[0].

Specifically, the storage position determination section 3303 may extract the bank address BA of the second area and transmit the refresh control signal PPRE for each page for controlling whether to perform a refresh or a refresh cycle for each extracted bank.

The memory module 200 may extract the bank address BA and the refresh control signal PBRE for that bank from the refresh command for each bank transmitted from the controller 300, and turn on or off a refresh operation on a corresponding bank. For example, when a logic level of the refresh control signal PBRE for a bank indicated by a refresh command REFSB is a logic low level, no refresh may be performed on the rows of cells of the indicated bank.

As described in FIG. 5 and FIG. 6, whether refresh is on or off may be controlled in units of a specific bank constituting the memory module 200 (FIG. 6) or in units of specific rows of a specific bank (FIG. 5).

FIG. 7 illustrates a lookup table 3307 for use in a process for setting a refresh cycle for each specific bank or for each row of the specific bank.

In order to set a refresh cycle in units of specific banks constituting the memory module 200 or in units of specific rows of the specific bank, the refresh cycle setting section 3305 may set refresh cycles for the first area and the second area on the basis of the application type recognized by the application recognition section 3301 and the data storage position provided from the storage position determination section 3303. In an embodiment, a memory bank included in the first area where the program code is stored may be refreshed according to the refresh cycle defined in a standard for the memory that makes up the bank. For example, a Double-Data Rate (DDR) DRAM according to a Joint Electron Device Engineering Council (JEDEC) may have a standard refresh cycle wherein each row of the DDR DRAM is refreshed within 64 milliseconds. In an embodiment, a memory bank included in the second area that stores data that may safely be lost may be refreshed using a refresh cycle longer than the refresh cycle defined in the standard, for example, a refresh cycle N times longer, where N is a rational number greater than 1.

The refresh cycle setting section 3305 may store, as the lookup table 3307, data regarding the refresh cycle for each unit of data storage, that is, each bank address and/or each row address. Then, the refresh cycle setting section 3305 may transmit a refresh command to a specific bank or a specific row of the specific bank according to the information stored in the lookup table 3307. In particular, when the REF on/off field in an entry of the lookup table 3307 corresponding to a specific bank or row in a bank is set, the refresh cycle setting section 3305 may transmit a refresh command to that bank or row at a rate corresponding to the cycle field of the entry for that bank or row

The memory module 200 may perform the refresh in response to the refresh command transmitted from the controller 300 at each cycle defined in the lookup table 3307.

Artificial intelligence is a field of research relating to imitating human intelligence and has directly or indirectly influenced various fields including computer science and semiconductor technology.

As a result of recent research on artificial neural network algorithms and machine learning, the accuracy of image recognition, natural language processing and the like has been improved to the human level and in the future, an artificial intelligence technology with high accuracy is expected to be realized in the fields of autonomous vehicles, automation systems, and the like.

When performing an artificial intelligence algorithm, the in-memory retention time of data generated during performance of the algorithm may be controlled as described in the present disclosure, which may increase the power efficiency of the data processing system 100 performing the algorithm.

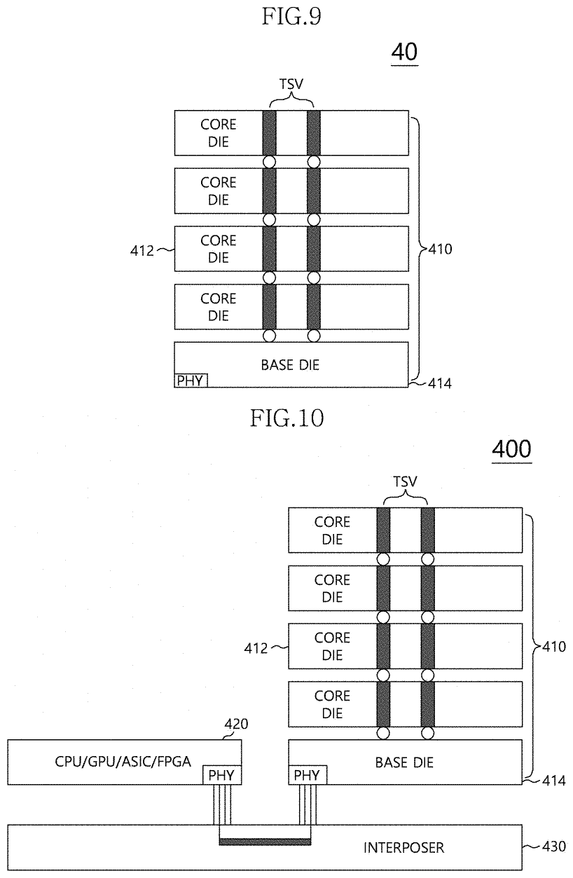

FIG. 8 is a flowchart illustrating an operating process of the data processing system 100 of FIG. 1 in accordance with an embodiment.

When the data processing system 100 (S101) is operating or in standby, the host 10 may request that an operation of a specific application to be offloaded to and processed by the data processing system 100 (S103).

To this end, the host 10 may transmit the type of the application and a program code storage address of the application to the data processing system 100 (S105). Accordingly, the program code stored at the program code storage address (in, for example, a corresponding area of the nonvolatile memory apparatus 202) may be loaded into the first area of the volatile memory apparatus 204 and data generated by executing the program code by the controller 300 may be stored in the second area of the volatile memory apparatus 204.

The controller 300 may determine the address of the first area where the program code is loaded and the address of the second area where data is to be stored (S107).

Then, the controller 300 may control, based on the type of the application, whether and with what refresh cycle to refresh a memory bank included in the first area, and whether and with what refresh cycle to refresh a memory bank included in the second area (S109).

In an embodiment, the memory bank included in the first area where the program code is stored may be refreshed according to the refresh cycle defined in an applicable standard (such an applicable DRAM standard). In an embodiment, the memory bank is included in the second area that stores data that may safely be lost may be refreshed using a refresh cycle longer than the refresh cycle defined in the standard, for example, a refresh cycle N times longer (N is a rational number greater than 1), or may not be refreshed.

A control signal for controlling whether to perform the refresh or the refresh cycle may be transmitted through an operation control command for each memory bank or an operation control command for each page (row) of the memory bank; however, embodiments are not limited thereto.

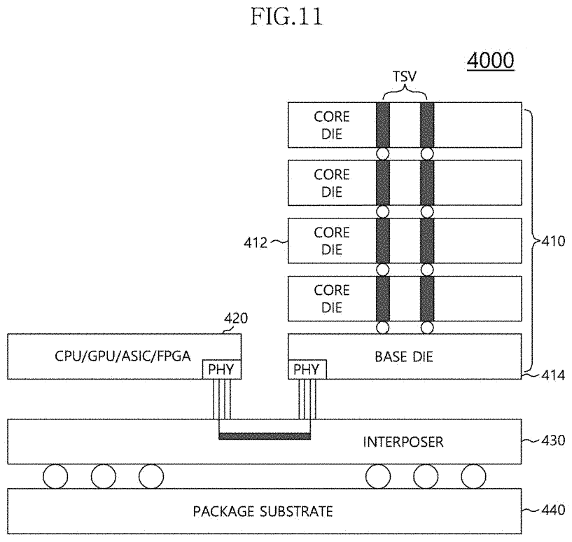

FIGS. 9 to 11 illustrate stacked semiconductor apparatuses in accordance with embodiments.

FIG. 9 illustrates a stacked semiconductor apparatus 40 in accordance with an embodiment.

The stacked semiconductor apparatus 40 may include a stack structure 410 in which a plurality of dies are stacked. The stack structure 410 may be configured in a high bandwidth memory (HBM) type in which the plurality of dies are stacked and electrically connected to one another via through-silicon vias (TSV), so that the number of input/output units is increased and thus a bandwidth is increased.

The stack structure 410 may include a base die 414 and a plurality of core dies 412.

The plurality of core dies 412 may be stacked on the base die 414 and electrically connected to one another via the through-silicon vias (TSV). In each of the core dies 412, memory cells for storing data and circuits for core operations of the memory cells may be disposed.

The core dies 412 may be electrically connected to the base die 414 via the through-silicon vias (TSV) and receive signals, power and the like from the base die 414 via the through-silicon vias (TSV).

The base die 414, for example, may include the controller 300 illustrated in FIGS. 1, 3, and 4. The base die 414 may perform various functions in the stacked semiconductor apparatus 40, for example, memory management functions such as power management and refresh of the memory cells or timing adjustment functions between the core dies 412 and the base die 414.

A physical interface area PHY included in the base die 414 may be an input/output area of an address, a command, data, a control signal and the like. The physical interface area PHY may be provided with a predetermined number of input/output circuits capable of satisfying a data processing speed required for the stacked semiconductor apparatus 40. A plurality of input/output terminals and a power supply terminal may be provided in the physical interface area PHY on the rear surface of the base die 414 to receive signals and power required for an input/output operation.

FIG. 10 illustrates a stacked semiconductor apparatus 400 in accordance with an embodiment.

The stacked semiconductor apparatus 400 may include a stack structure 410 of a plurality of core dies 412 and a base die 414, a memory host 420, and an interface substrate 430. The memory host 420 may be a CPU, a GPU, an application specific integrated circuit (ASIC), a field programmable gate arrays (FPGA) and the like.

The base die 414 may be provided with a circuit for an interface between the core dies 412 and the memory host 420. The stack structure 410 may have a structure similar to that described with reference to FIG. 9.

A physical interface area PHY of the stack structure 410 and a physical interface area PHY of the memory host 420 may be electrically connected to each other through the interface substrate 430. The interface substrate 430 may be referred to as an interposer.

FIG. 11 illustrates a stacked semiconductor apparatus 4000 in accordance with an embodiment.

It may be understood that the stacked semiconductor apparatus 4000 illustrated in FIG. 11 is obtained by disposing the stacked semiconductor apparatus 400 illustrated in FIG. 10 on a package substrate 440.

The package substrate 440 and the interface substrate 430 may be electrically connected to each other through connection terminals.

A system in package (SiP) type semiconductor apparatus may be implemented by staking the stack structure 410 and the memory host 420, which are illustrated in FIG. 10, on the interface substrate 430 and mounting them on the package substrate 440 for the purpose of package.

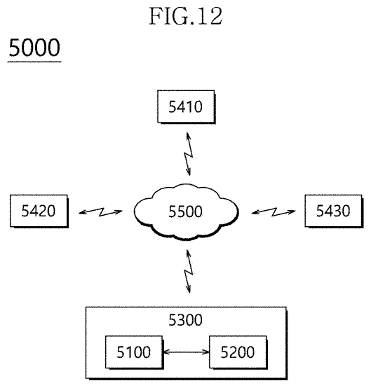

FIG. 12 is a diagram illustrating a network system 5000 including a data storage device, in accordance with an embodiment. Referring to FIG. 12, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may include one or more of the data processing system 100 shown in FIG. 1, the stacked semiconductor apparatuses 40 shown in FIG. 9, the stacked semiconductor apparatus 400 shown in FIG. 10, or the stacked semiconductor apparatus 4000 shown in FIG. 11, or combinations thereof.

While various embodiments have been described above, it will be understood to those skilled in the art that the embodiments described are examples only. Accordingly, the data processing system and the operating method thereof described herein should not be limited based on the described embodiments.

What is claimed is:

1. A data processing system comprising:
a memory module including a plurality of memory banks, the memory banks including a plurality of pages; and
a controller configured to control the memory module,
wherein the controller is configured to:
receive a type of an application and a storage address of a program code of the application,
execute the program code,
store data generated by the execution of the program code in the memory module, and
control, based on the type of the application, whether to refresh the memory module or a refresh cycle of the memory module.

2. The data processing system according to claim 1, wherein the controller is configured to load the program code into a first area of the memory module and refresh a memory bank included in the first area according to a preset refresh cycle.

3. The data processing system according to claim 1, wherein the controller is configured to store the generated data in a second area of the memory module and to control whether to perform a refresh of a memory bank included in the second area, a refresh cycle for the memory bank included in the second area, or both.

4. The data processing system according to claim 1, wherein the controller is configured to control whether to refresh a memory bank of the memory banks by using an operation control command for the memory bank.

5. The data processing system according to claim 4, wherein the operation control command includes an active command.

6. The data processing system according to claim 1, wherein the controller is configured to store the data in a second area of the memory module and control whether to perform a refresh of a page of a memory bank included in the second area, a refresh cycle for the page of the memory bank included in the second area, or both.

7. The data processing system according to claim 6, wherein the controller is configured to control whether to refresh the memory banks by using an operation control command for each page of the memory bank.

8. The data processing system according to claim 7, wherein the operation control command for each bank includes a refresh command.

9. The data processing system according to claim 1, wherein the controller includes a lookup table that stores a refresh cycle for each memory bank or for each page of the memory banks, and is configured to transmit a refresh command to the memory module based on the refresh cycle stored in the lookup table.

10. The data processing system according to claim 1, wherein the type of the application is determined according to characteristics indicating whether data generated in processing the offloaded operation by the controller may safely be lost.

11. An operating method of a data processing system including a memory module composed of a plurality of memory banks including a plurality of pages and a controller configured to control the memory module, the operating method comprising:
when a host requests operation processing for an application, receiving, by the controller from the host, a type of the application and a storage address of a program code of the application;
determining, by the controller, an address of the memory module into which the program code is loaded and an address of the memory module for storing data generated by the execution of the program code; and
a refresh control step including controlling, by the controller based on the type of the application, whether to refresh the memory module, a refresh cycle of the memory module, or both.

12. The operating method according to claim 11, further comprising:
loading, by the controller, the program code into a first area of the memory module,
wherein the refresh control step comprises controlling a memory bank included in the first area to be refreshed according to a preset refresh cycle.

13. The operating method according to claim 11, further comprising:
storing, by the controller, the data in a second area of the memory module,
wherein the refresh control step comprises controlling, by the controller, whether to perform a refresh for each memory bank included in the second area, a refresh cycle for each memory bank included in the second area, or both.

14. The operating method according to claim 11, wherein the refresh control step comprises:
including, by the controller, refresh control information in an operation control command for a memory bank, and
transmitting the operation control command for the memory bank to the memory module.

15. The operating method according to claim 14, wherein the operation control command includes an active command.

16. The operating method according to claim 11, further comprising:
storing, by the controller, the data in a second area of the memory module,
wherein the refresh control step comprises controlling, by the controller, whether to perform a refresh for each page of a memory bank included in the second area, a refresh cycle for each page of the memory bank included in the second area, or both.

17. The operating method according to claim 16, wherein the refresh control step comprises:
including, by the controller, refresh control information into an operation control command for each page of the memory bank, and
transmitting, to the memory module, the operation control command for each page of the memory bank.

18. The operating method according to claim 17, wherein the operation control command for each bank includes a refresh command.

19. The operating method according to claim 11, wherein the controller includes a lookup table that stores a refresh cycle for each memory bank or for each page of the memory bank, and wherein the refresh control step comprises:
transmitting, by the controller based on the cycle stored in the lookup table, a refresh command to the memory module.

20. The operating method according to claim 11, wherein the type of the application is determined according to characteristics indicating whether data generated in processing the offloaded operation by the controller may safely be lost.
